(19) United States
(12) Patent Application Publication
(10) Pub. No.: US 2024/0044280 A1
(43) Pub. Date: Feb. 8, 2024

(54) COOLING SYSTEM FOR A PRIME MOVER

(71) Applicant: Girish Mandakolathur Krishnamurthi, Bengaluru (IN)

(72) Inventor: Girish Mandakolathur Krishnamurthi, Bengaluru (IN)

(21) Appl. No.: 17/882,530

(22) Filed: Aug. 6, 2022

(51) Int. Cl. F01P 3/22

(52) U.S. Cl. CPC F01P 3/2285

(57) ABSTRACT

A cooling system for a prime mover is disclosed. The cooling system comprises at least one cooling jacket defined within a housing of the prime mover and receives refrigerant therein for cooling the prime mover. A compressor is in flow communication with an outlet port of the at least one cooling jacket and compresses refrigerant that flows from the outlet port of the at least one cooling jacket. A condenser is in flow communication with an outlet port of the compressor and discharges heat from refrigerant that is received from the compressor. An expansion device is in flow communication with an outlet port of the condenser at its inlet port and in flow communication with an inlet port of the at least one cooling jacket at its outlet port. The expansion device controls a flow of refrigerant from the condenser to the at least one cooling jacket is also disclosed.

### FIELD OF THE INVENTION

This invention relates generally to a cooling system for a machine, and more particularly to the cooling system for cooling a prime mover that converts energy to useful work.

### BACKGROUND OF THE INVENTION

In a current design of a prime mover such as an internal combustion engine, liquid coolant from a radiator is allowed to flow to a cooling system of the internal combustion engine. A liquid coolant from the radiator that flows to the cooling system of the internal combustion engine is channeled through a plurality of cooling jackets of the internal combustion engine. More specifically, the liquid coolant that is channeled through the plurality of cooling jackets of the internal combustion engine absorbs heat from a plurality of high temperature pistons and high temperature cylinders of the internal combustion engine as is in a case of a multi-cylinder internal combustion engine, thereby cooling the plurality of pistons and the plurality of cylinders of the internal combustion engine. The liquid coolant that flows from an outlet port of a cooling jacket of an internal combustion engine at a high temperature is channeled to a thermostat valve that determines a temperature of the liquid coolant that flows from the outlet port of the cooling jacket of the internal combustion engine. If the temperature of the liquid coolant that flows from the outlet port of the cooling jacket of the internal combustion engine is lower than a threshold temperature that is pre-determined by a user, the liquid coolant is channeled back to the plurality of cooling jackets of the internal combustion engine by bypassing a coolant tank. If the temperature of the liquid coolant that flows from the outlet port of the cooling jacket of the internal combustion engine is greater than the threshold temperature that is pre-determined by the user, the liquid coolant is channeled to the coolant tank of the internal combustion engine and stored therein. The liquid coolant that is stored within the coolant tank of the internal combustion engine is therein channeled to a variable speed electric pump. The liquid coolant that is channeled to the variable speed electric pump from the coolant tank is circulated by the variable speed electric pump and therein delivered to a radiator. An engine control unit regulates a speed of the variable speed electric pump. More specifically, the speed of the variable speed electric pump is regulated by the engine control unit based on a speed of the internal combustion engine. Therefore, an operating speed of the variable speed electric pump is directly proportional to an operating speed of the internal combustion engine and is controlled by the engine control unit accordingly. The liquid coolant that is delivered to the radiator from the variable speed electric pump is cooled in the radiator by means of high speed cooling air that is directed towards the radiator by means of a cooling fan. Once excess heat from the liquid coolant is dissipated in the radiator due to the high speed cooling air that is directed towards the radiator by means of the cooling fan, the low temperature liquid coolant is channeled from the radiator through the plurality of cooling jackets of the internal combustion engine for cooling the plurality of pistons and cylinders that are positioned within the plurality of cooling jackets of the internal combustion engine respectively.

However, as the liquid coolant is in a liquid state and having a low specific heat absorption capacity, absorption of heat from the plurality of pistons and cylinders of the internal combustion engine is low per unit mass of liquid coolant that flows through the plurality of cooling jackets of the internal combustion engine. Moreover, as the liquid coolant in the liquid state from the radiator is channeled through the plurality of cooling jackets of the internal combustion engine and channeled to the variable speed electric pump via the coolant tank, a number of iterations in which a pre-determined quantity of liquid coolant is required to be circulated through the plurality of cooling jackets of the internal combustion engine until each of the plurality of pistons and cylinders of the internal combustion engine is cooled by a required temperature differential is high. Therefore, energy expended by the variable speed electric pump to circulate the liquid coolant through the cooling system of the internal combustion engine multiple times iteratively until each of the plurality of pistons and plurality of cylinders of the internal combustion engine is cooled by the required temperature differential is correspondingly high. In addition, as the liquid coolant is in the liquid state, the energy expended by the variable speed electric pump to channel the liquid coolant from the radiator through the plurality of cooling jackets of the internal combustion engine and back to the variable speed electric pump via the coolant tank is high. This is because a force exerted by the variable speed electric pump to cause liquid coolant to flow from the radiator through the plurality of cooling jackets of the internal combustion engine and, back to the variable speed electric pump via the coolant tank is high due to a high viscosity of the liquid coolant. A solution is hereby proposed in this manuscript to circulate a refrigerant through the plurality of cooling jackets of the internal combustion engine to cool each of the plurality of pistons and cylinders of the internal combustion engine by the required temperature differential, thereby resulting in an increase in a mechanical efficiency of the cooling system of the internal combustion engine. Moreover, as the refrigerant is in a gaseous state after absorbing heat from each of the plurality of pistons and plurality of cylinders of the internal combustion engine, energy required to circulate gaseous refrigerant through the cooling system of the internal combustion engine is much lower than energy required to circulate liquid coolant through the cooling system of the internal combustion engine. In addition, the specific heat absorption capacity per unit volume of the refrigerant is much higher than the specific heat absorption capacity per unit volume of the liquid coolant. Therefore, the efficiency of heat absorption by the refrigerant that is channeled through the cooling system of the internal combustion engine is higher than the efficiency of heat absorption by the liquid coolant that is channeled through the cooling system of the internal combustion engine. In an exemplary example, the liquid coolant may be but is not limited to inorganic Additive Technology, Organic Acid Technology, and Hybrid Organic Acid Technology.

A traditional cooling system for the internal combustion engine comprises the internal combustion engine that includes an inlet port and an outlet port. The inlet port of the cooling jacket of the internal combustion engine is in flow communication with an outlet port of the radiator and receives low temperature liquid coolant that is discharged from the radiator. The low temperature liquid coolant that is channeled to the inlet port of the cooling jacket of the internal combustion engine flows through the plurality of cooling jackets that are defined around the plurality of cylinders of the internal combustion engine. More specifically, the plurality of cooling jackets that are defined around the plurality of pistons and plurality of cylinders of the internal combustion engine are in flow communication with the inlet port of the plurality of cooling jackets of the internal combustion engine at its first end. In addition, the plurality of cooling jackets that are defined around the plurality of pistons and plurality of cylinders of the internal combustion engine are in flow communication with the outlet port of the cooling jacket of the internal combustion engine at its opposite second end. The low temperature liquid coolant that is channeled from the outlet port of the radiator is channeled through the plurality of cooling jackets of the internal combustion engine via the inlet port defined in the plurality of cooling jackets of the internal combustion engine. After absorbing heat from the plurality of cylinders of the internal combustion engine while flowing through the plurality of cooling jackets of the internal combustion engine, high temperature liquid coolant is channeled through the outlet port of the cooling jacket of the internal combustion engine. Consequently, a temperature of the plurality of pistons and plurality of cylinders that are each positioned within the plurality of cooling jackets of the internal combustion engine is decreased by pre-determined temperature differences for various operating speeds of the internal combustion engine. However, a mass flow rate of liquid coolant that is required to be channeled through the plurality of cooling jackets in order to achieve the required temperature decrease in each of the plurality of pistons and plurality of cylinders of the internal combustion engine is high due to the low specific heat absorption capacity of the liquid coolant. Moreover, due to the high mass flow rate of liquid coolant that flows through the plurality of cooling jackets and that the liquid coolant is in the liquid state with a corresponding high viscosity, energy expended by the variable speed electric pump to circulate the liquid coolant through the plurality of cooling jackets of the internal combustion engine to achieve the required temperature decrease in each of the plurality of pistons and plurality of cylinders of the internal combustion engine is high. Owing to high mass flow rate and high viscosity of the liquid coolant, a mechanical efficiency of the cooling system of the internal combustion engine is low. Consequently, there exists a need for an improved cooling system for the internal combustion engine that would enable a lower mass flow rate and lower viscosity of refrigerant than that of the liquid coolant to be channeled through the plurality of cooling jackets of the internal combustion engine in order to achieve the required temperature reduction in each of the plurality of pistons and plurality of cylinders of the internal combustion engine due to the high specific heat absorption capacity of the refrigerant. Due to the change in the phase of the refrigerant from the liquid phase to the gaseous phase as it flows through the plurality of cooling jackets of the internal combustion engine with a corresponding lower viscosity and lower mass flow rate, energy expended by a compressor to circulate gaseous refrigerant through the plurality of cooling jackets of the internal combustion engine to achieve the required temperature reduction in each of the plurality of pistons and plurality of cylinders of the internal combustion engine is low.

The need has existed for many years, yet there is no fully satisfactory system to meet the need. In accord with a long recognized need, there has been developed a cooling system for a prime mover that would enable refrigerant to be channeled through the plurality of cooling jackets of the prime mover, wherein the prime mover may be but is not limited to an internal combustion engine. The refrigerant that is channeled through the plurality of cooling jackets of the internal combustion engine changes its phase from the liquid phase to the gaseous phase as it flows from the inlet port that is in flow communication with the plurality of cooling jackets to the outlet port that is in flow communication with the plurality of cooling jackets of the internal combustion engine. The refrigerant that is channeled through the plurality of cooling jackets of the internal combustion engine is designed to increase the mechanical efficiency of the cooling system for the internal combustion engine. More specifically, as the specific heat absorption capacity of the refrigerant is high in comparison with the specific heat absorption capacity of the liquid coolant that is low, the mass flow rate of the refrigerant that is required to be channeled through the plurality of cooling jackets of the internal combustion engine can be substantially decreased in comparison with a high mass flow rate of the liquid coolant that is required to be channeled through the plurality of cooling jackets of the internal combustion engine in order to achieve a substantially same temperature reduction in the plurality of pistons and plurality of cylinders of the internal combustion engine. Moreover, as the refrigerant changes from the liquid state to the gaseous state as it flows through the plurality of cooling jackets of the internal combustion engine, energy required to circulate the gaseous refrigerant through the cooling system of the internal combustion engine by means of the compressor may be substantially decreased in comparison with energy required to circulate the liquid coolant through the cooling system of the internal combustion engine by means of the variable speed electric pump.

### BRIEF DESCRIPTION OF THE INVENTION

In one aspect of the invention, a method of assembling a prime mover is described. The method comprises positioning at least one mechanical component within a housing of the prime mover, wherein the at least one mechanical component converts one of energy to useful work and useful work to energy, and defining at least one cooling jacket within the housing of the prime mover and defined around the at least one mechanical component, the at least one cooling jacket comprising an inlet port and an outlet port. The method further comprises channeling refrigerant in a substantially liquid state at a low temperature through the inlet port of the at least one cooling jacket such that the refrigerant that is channeled in the substantially liquid state at the low temperature through the inlet port of the at least one cooling jacket flows past the at least one mechanical component positioned within the at least one cooling jacket to cool the at least one mechanical component positioned within the at least one cooling jacket, and delivering refrigerant that flows past the at least one mechanical component positioned within the at least one cooling jacket to cool the at least one mechanical component positioned within the at least one cooling jacket through the outlet port of the at least one cooling jacket in a substantially gaseous state at a high temperature due to absorption of heat by the refrigerant from the at least one mechanical component positioned within the at least one cooling jacket.

In another aspect of the invention, a cooling system for a prime mover that converts one of energy to useful work and useful work to energy is described. The cooling system comprises at least one cooling jacket defined within a housing of the prime mover and receives a refrigerant therein. The refrigerant that is received within the at least one cooling jacket flows through the at least one cooling jacket defined within the housing of the prime mover to facilitate cooling the prime mover. A compressor is in flow communication with an outlet port of the at least one cooling jacket defined within the housing of the prime mover. The compressor receives refrigerant that flows through the outlet port of the at least one cooling jacket. The compressor compresses the refrigerant that is received in the compressor. A condenser is in flow communication with an outlet port of the compressor. The condenser receives refrigerant that flows through the outlet port of the compressor and discharges heat from the refrigerant that is received in the condenser. An expansion device is in flow communication with an outlet port of the condenser at its inlet port and receives refrigerant that flows through the outlet port of the condenser. The expansion device is in flow communication with an inlet port of the at least one cooling jacket defined within the housing of the prime mover at its outlet port. The expansion device controls a flow of refrigerant that flows through the outlet port of the condenser to the inlet port of the at least one cooling jacket defined within the housing of the prime mover.

In a further aspect of the invention, a prime mover is described. The prime mover comprises a housing, and at least one mechanical component positioned within the housing of the prime mover. The at least one mechanical component converts one of energy to useful work and useful work to energy. At least one cooling jacket is defined within the housing of the prime mover and defined around the at least one mechanical component. The at least one cooling jacket comprises an inlet port and an outlet port. The inlet port of the at least one cooling jacket receives refrigerant in a substantially liquid state at a low temperature, wherein the refrigerant in the substantially liquid state at the low temperature that is received through the inlet port of the at least one cooling jacket flows past the at least one mechanical component positioned within the at least one cooling jacket to cool the at least one mechanical component positioned within the at least one cooling jacket. The refrigerant is therein delivered through the outlet port of the at least one cooling jacket in a substantially gaseous state at a high temperature due to absorption of heat by the refrigerant from the at least one mechanical component that is positioned within the at least one cooling jacket.

### BRIEF DESCRIPTION OF THE DRAWINGS

FIG. 1 is a schematic representation of a cooling system for a prime mover in one embodiment of the invention.

FIG. 2 is a schematic representation of the prime mover comprising a plurality of cooling jackets that are in flow communication with a compressor, a condenser, and an expansion device in one embodiment of the invention.

FIG. 3 is a flowchart representing a method of assembling the prime mover in one embodiment of the invention.

### DETAILED DESCRIPTION OF THE INVENTION

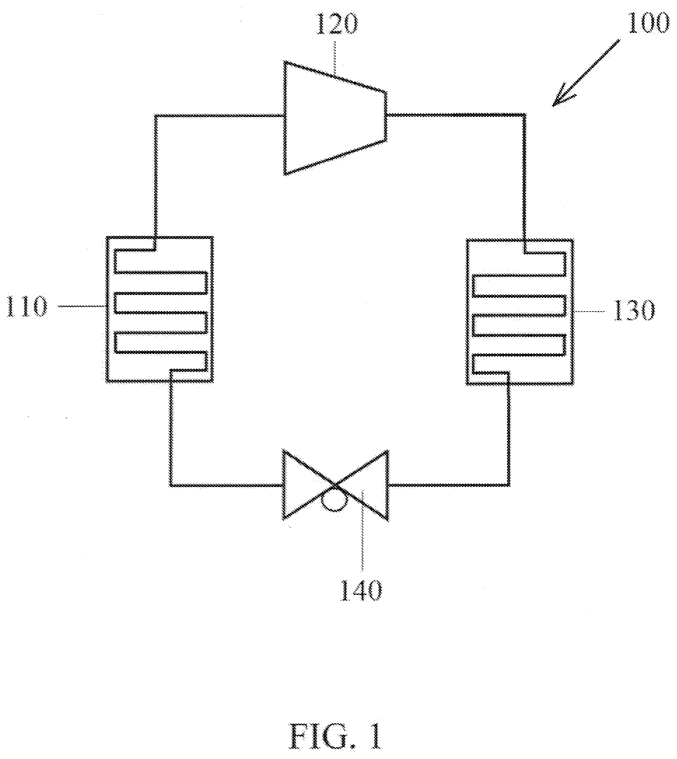

FIG. 1 is a schematic representation of a cooling system 100 for a prime mover 110 in one embodiment of the invention. The cooling system 100 for the prime mover 110 comprises at least one cooling jacket that is defined within a housing of the prime mover 110 that receives a refrigerant from an expansion device 140 via an inlet port defined in the at least one cooling jacket, wherein the refrigerant flows past at least one mechanical component positioned within the housing of the prime mover for cooling the mechanical component, and wherein the refrigerant from the at least one cooling jacket flows to a compressor 120 via an outlet port that is defined in the at least one cooling jacket. More specifically, the at least one cooling jacket that is defined within the housing of the prime mover 110 receives the refrigerant that is in a substantially liquid state via the inlet port that is defined in the at least one cooling jacket. When the liquid refrigerant flows past the at least one mechanical component that is positioned within the housing of the prime mover 110 for cooling the mechanical component, heat is absorbed from the at least one mechanical component by the liquid refrigerant, thereby changing its state to a substantially gaseous state. The refrigerant that is in the substantially gaseous state is channeled from the at least one cooling jacket to the compressor 120 via the outlet port that is defined in the at least one cooling jacket. In an exemplary embodiment, the prime mover 110 may be an internal combustion engine that delivers rotational torque to wheels of an automobile. In an alternate exemplary embodiment, the prime mover 110 may be an electric motor that delivers rotational torque to wheels of the automobile. In yet another alternate exemplary embodiment, the prime mover 110 may be any prime mover that requires to be cooled as a consequence of heating up during a process of converting one of energy to useful work and useful work to energy respectively.

Once the refrigerant absorbs heat from the prime mover 110, the refrigerant from the prime mover 110 is channeled to the compressor 120 for compressing the refrigerant that flows from the prime mover 110. Once refrigerant is compressed in the compressor 120, the compressed refrigerant is channeled to the condenser 130 for discharging heat from the compressed refrigerant. Therein the refrigerant is channeled to the expansion device 140 for throttling the refrigerant. The refrigerant from the expansion device is channeled back to the prime mover 110, and recirculation therethrough for absorbing heat from the prime mover 110.

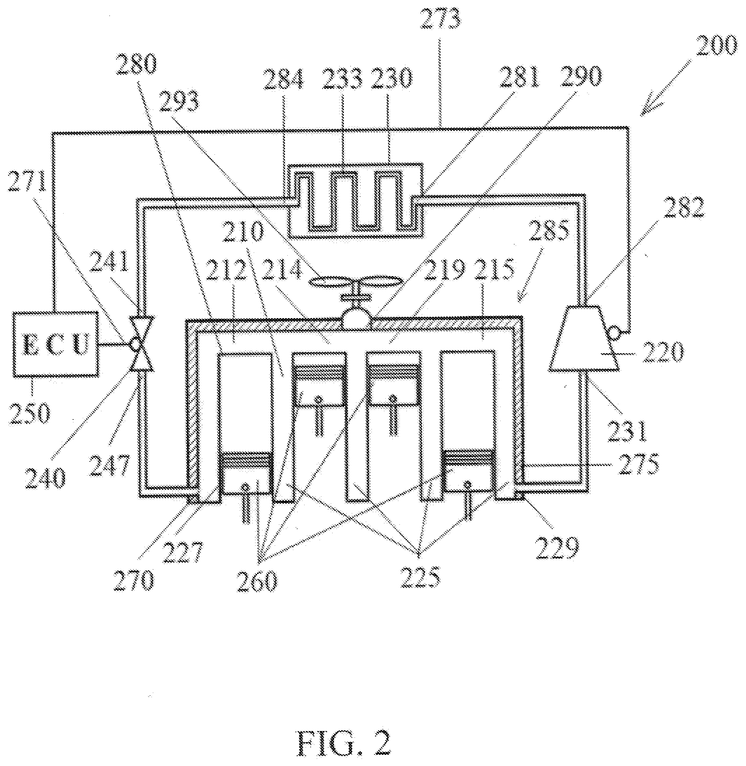

FIG. 2 is a schematic representation of a prime mover 285 comprising a plurality of cooling jackets that are in flow communication with a compressor 220, a condenser 230, and an expansion device 240 in one embodiment of the invention. The cooling system 200 for the prime mover 285 comprises at least one cooling jacket 210 that is defined within the housing 275 of the prime mover 285 and receives a refrigerant therein. In an exemplary embodiment, the refrigerant deployed in the cooling system 200 for the prime mover 285 may be one of Formaldehyde, R-11, R-12. R-22, R-32, R-115, R-134A, R-290, R-407C, R-410A, and R-600A. In an alternate exemplary embodiment, the refrigerant deployed in the cooling system 200 for the prime mover 285 may be any refrigerant known in the art that cools the prime mover 285 which becomes heated up during its process of conversion of one of energy to useful work and useful work to energy.

More specifically, the at least one cooling jacket 210 that is defined within the housing 275 of the prime mover 285 comprises a plurality of bores that are defined within the housing 275 of the prime mover 285. The plurality of bores that are defined within the housing 275 of the prime mover 285 comprises a primary bore containing a first cooling jacket 212, a second cooling jacket 214, a third cooling jacket 219, and a fourth cooling jacket 215 that extends through the housing 275 of the prime mover 285 and a plurality of auxiliary bores 225 that are positioned orthogonally with respect to the primary bore and are in flow communication with the primary bore. The primary bore and the plurality of auxiliary bores 225 that are positioned orthogonally with respect to the primary bore extend around the housing 275 of the prime mover 285 and covers a maximum possible surface area of the housing 275 of the prime mover 285 and the mechanical component 260 to facilitate absorbing heat from the prime mover 285. In addition, the plurality of bores that are defined within the housing 275 of the prime mover 285 comprises the primary bore that extends around the housing 275 of the prime mover 285 such that the primary bore encompasses a maximum surface area of the housing 275 of the prime mover 285 that is parallel to a longitudinal axis of the primary bore. The plurality of auxiliary bores 225 that are positioned orthogonally with respect to the primary bore are each in flow communication with the primary bore and extend around the housing 275 of the prime mover 285 and covers a maximum possible surface area of the housing 275 of the prime mover 285 that is parallel to an axis of the plurality of auxiliary bores 225 to facilitate absorbing heat from the prime mover 285. Therefore, the primary bore and the plurality of auxiliary bores 225 that together cover a maximum surface area of the housing 275 of the prime mover 285 facilitate absorbing heat from the prime mover 285 by means of the refrigerant, thereby cooling the prime mover 285 effectively.

In the exemplary embodiment, the refrigerant that is received within the at least one cooling jacket 210 is received within the at least one cooling jacket 210 in a substantially liquid state. Once the refrigerant is received within the at least one cooling jacket 210 in the substantially liquid state, the refrigerant is allowed to flow through the at least one cooling jacket 210 defined within the housing 275 of the prime mover 285 to facilitate cooling the prime mover 285. More specifically, the refrigerant is allowed to flow through the primary bore of the at least one cooling jacket 210 and each of the plurality of auxiliary bores 225 that are orthogonally positioned and in flow communication with the primary bore. Therefore, the refrigerant that flows through the primary bore and each of the plurality of auxiliary bores 225 that are orthogonally positioned and in flow communication with the primary bore of the at least one cooling jacket 210 facilitate absorbing heat from the prime mover 285. The absorption of heat by the refrigerant from the prime mover 285 cools the prime mover 285 from a higher temperature to a lower temperature.

In an exemplary embodiment, a compressor 120 is in flow communication with an outlet port 229 of the at least one cooling jacket 210 defined within the housing 275 of the prime mover 110 and receives refrigerant that flows from the outlet port 229 of the at least one cooling jacket 210. More specifically, the refrigerant that is received within the compressor 220 from the at least one cooling jacket 210 is in a substantially gaseous state and is received via an inlet port 231 of the compressor 120. Once the refrigerant is received within the compressor 120 in the substantially gaseous state, the gaseous refrigerant is compressed by the compressor 120 from a pressure that is equal to the pressure of the refrigerant at the outlet port 229 of the at least one cooling jacket 210 to a higher pressure that is required for the refrigerant to be circulated through the cooling system 200 for the prime mover 110. More specifically, the compressor 120 may be a mechanical compressor that is driven by a driveshaft of the engine to increase the pressure of refrigerant from the low pressure at the outlet port 229 of the at least one cooling jacket 210 to the higher pressure. In an alternate exemplary embodiment, the compressor 120 may be an electric compressor with power being supplied from an electric battery to increase the pressure of refrigerant from the low pressure at the outlet port 229 of the at least one cooling jacket 210 to the higher pressure. In an exemplary embodiment, the compressor 120 may be any compressor known in the art that increases the pressure of refrigerant from the low pressure at the outlet port 229 of the at least one cooling jacket 210 to the higher pressure. Therefore, as the refrigerant is received in the compressor 120, the pressure of the refrigerant is increased by the compressor 120 from the low pressure to the high pressure with a corresponding large increase in temperature of the refrigerant that is in the substantially gaseous state. More specifically, owing to the large increase in the pressure of the gaseous refrigerant by the compressor 220, the temperature of the gaseous refrigerant is substantially increased to a high temperature. In an exemplary embodiment, a condenser 130 is in flow communication with an outlet port 282 of the compressor 120. An outlet valve (not shown) is in flow communication between the outlet port 229 of the at least one cooling jacket 210 and the inlet port 231 of the compressor 220. More specifically, the outlet valve is in flow communication between the outlet port 229 of the at least one cooling jacket 210 and the inlet port 231 of the compressor 220 and is electronically connected to the ECU 250 via a control flow path and controls a flow of refrigerant from the outlet port 229 of the at least one cooling jacket 210 to the inlet port 231 of the compressor 220.

In an exemplary embodiment, a condenser 130 is in flow communication with the outlet port 282 of the compressor 120 at its inlet port 281 and receives refrigerant that flows from the outlet port 282 of the compressor 120. More specifically, the refrigerant that is received within the condenser 130 via its inlet port 281 is received from the compressor 220 in a substantially gaseous state. Once the refrigerant is received within the condenser 130 in the substantially gaseous state, heat that is present within the gaseous refrigerant that was absorbed from the prime mover 110 while the refrigerant was flowing through the at least one cooling jacket 210 is dissipated in the condenser 130. The heat from the gaseous refrigerant is discharged in the condenser 130, thereby decreasing the temperature of the gaseous refrigerant from the temperature of the refrigerant at the outlet port 282 of the compressor 120 to a lower temperature that is required for the refrigerant to be circulated through the cooling system 100 for the prime mover 110. More specifically, the condenser 130 may be a mechanical heat exchanger for discharging the heat from the gaseous refrigerant to an external environment. More specifically, the heat exchanger may be one of a liquid cooled and an air cooled heat exchanger that facilitates decreasing the temperature of the refrigerant from the temperature at the outlet port 282 of the compressor 220 to a lower temperature that is required for the refrigerant to be circulated through the cooling system 100 of the prime mover 110. In an alternate exemplary embodiment, the condenser 130 may be any condenser 130 known in the art that facilitates decreasing the high temperature of the gaseous refrigerant that is received in the condenser 130 via its inlet port to the lower temperature that is required for the gaseous refrigerant to be circulated through the cooling system 100 for the prime mover 110. As the temperature of the gaseous refrigerant decreases from the high temperature at the outlet port 282 of the compressor 120 to the lower temperature that is required for the refrigerant to be circulated through the cooling system 100 of the prime mover 110, the pressure of the refrigerant remains largely unaffected. More specifically, while the temperature of the gaseous refrigerant decreases as the refrigerant flows through the condenser 130, the pressure of the gaseous refrigerant remains steady or decreases to a slightly lower pressure from the high pressure gaseous refrigerant that is channeled from the outlet port 282 of the compressor 220 to the condenser 230 via the inlet port 281 of the condenser 230. Therefore, at an outlet port 284 of the condenser 230, gaseous refrigerant at high pressure and low temperature is channeled to the next stage of the cooling system 100 of the prime mover 110. In an exemplary embodiment, an expansion device 140 is in flow communication with an outlet port 284 of the condenser 230.

In an exemplary embodiment, the expansion device 140 is in flow communication with the outlet port 284 of the condenser 130 at its inlet port 241 and receives refrigerant that flows through the outlet port 284 of the condenser 230. More specifically, the refrigerant that is received at the inlet port 241 of the expansion device 240 is received from the outlet port 284 of the condenser 230 in a substantially gaseous state. Once the refrigerant is received at the inlet port 241 of the expansion device 240 in the substantially gaseous state, the expansion device 240 facilitates throttling the gaseous refrigerant, thereby decreasing the pressure of the gaseous refrigerant from the high pressure at the outlet port 284 of the condenser 230 to a lower pressure, and consequently decreasing the temperature of the gaseous refrigerant at the outlet port 284 of the condenser 230 to a lower temperature. More specifically, the decrease in the pressure of gaseous refrigerant from the high pressure at the outlet port 284 of the condenser 230 to the lower pressure due to the throttling action of the expansion device 240 causes a substantial reduction in the temperature of refrigerant from the temperature at the outlet port 284 of the condenser 130 to the lower temperature. The expansion device 140 is in flow communication with an inlet port 270 of the at least one cooling jacket 210 defined within the housing 275 of the prime mover 110 at its outlet port 247. The expansion device 240 controls the flow of refrigerant that flows through the outlet port 284 of the condenser 130 to the inlet port 270 of the at least one cooling jacket 210 defined within the housing 275 of the prime mover 110. More specifically, an engine control unit 250 is in electronic communication with the expansion device 240 via a control flow path 271. More specifically, the engine control unit 250 controls an opening percentage of the expansion device 240 to facilitate regulating a required mass flow rate of the gaseous refrigerant from the outlet port 284 of the condenser 230 to the inlet port 270 of the at least one cooling jacket 210 defined within the housing 275 of the prime mover 110 for the refrigerant to be circulated through the cooling system 100 for the prime mover 110. In addition, the engine control unit 250 is in electronic communication with the compressor 220 via a control flow path 273. More specifically, the engine control unit 250 controls a speed of the compressor 220 to facilitate regulating the required mass flow rate of the refrigerant from the outlet port 229 of the at least one cooling jacket 210 to the inlet port 281 of the condenser 230 for the refrigerant to be circulated through the cooling system 100 of the prime mover 110. More specifically, the expansion device 240 may be a mechanical control valve for controlling a flow of refrigerant from the outlet port 284 of the condenser 130 to the inlet port 270 of the at least one cooling jacket 210 defined within the housing 275 of the prime mover 110. In an alternate exemplary embodiment, the expansion device 240 may be an electronically actuated control valve for controlling the flow of refrigerant from the outlet port 284 of the condenser 130 to the inlet port 270 of the at least one cooling jacket 210 defined within the housing 275 of the prime mover 285. In an alternate exemplary embodiment, the expansion device 140 may be any expansion device known in the art that facilitates controlling the flow of refrigerant from the outlet port 284 of the condenser 130 to the inlet port 270 of the at least one cooling jacket 210 defined within the housing 275 of the prime mover 110.

As the pressure and the temperature of the refrigerant decreases from the high pressure and the low temperature at the outlet port 284 of the condenser 130 to the low pressure and much lower temperature at the outlet port 247 of the expansion device 240, the gaseous refrigerant changes its phase to a substantially liquid phase due to the reduction in its temperature. The refrigerant that is in the substantially liquid phase is allowed to flow through the inlet port 270 of the at least one cooling jacket 210 defined within the housing 275 of the prime mover 110 via the outlet port 247 of the expansion device 240 that throttles the refrigerant that flows from the outlet port 284 of the condenser 230. The throttling effect of the gaseous refrigerant that flows through the outlet port 284 of the condenser 230 to the inlet port 270 of the at least one cooling jacket 210 via the outlet port 247 of the expansion device 240 that is controlled by the engine control unit 250 permits only a required mass flow rate of liquid refrigerant to be channeled at a high speed through the inlet port 270 of the at least one cooling jacket 210. Therefore, at the outlet port 247 of the expansion device 240, substantially liquid refrigerant at a lower pressure and at a lower temperature than the pressure and the temperature of the refrigerant at the outlet port 284 of the condenser 130 is channeled to the next stage of the cooling system 100 of the prime mover 110. In an exemplary embodiment, the at least one cooling jacket 210 that is defined within the housing 275 of the prime mover 110 is in flow communication with the outlet port 247 of the expansion device 240 and receives high speed substantially liquid refrigerant at a low pressure and at a low temperature therein. The expansion device 240 described above may be a unidirectional expansion device that permits only a required mass flow rate of substantially liquid refrigerant to be channeled at the high speed, low pressure, and low temperature through the inlet port 270 of the at least one cooling jacket 210 defined within the housing 275 of the prime mover 110.

In an exemplary embodiment, the prime mover 110 may be but is not limited to a windmill, a waterwheel, a turbine, a steam engine, an internal combustion engine, an external combustion engine, an electric motor, and an electric generator. More specifically, the electric motor may be one of an alternating current electric motor and a direct current electric motor that converts electric energy to useful work. At least one cylinder 280 is defined within the at least one cooling jacket 210 defined within the housing 275 of the prime mover 110. Therefore, once the refrigerant flows through the at least one cooling jacket 210 that is defined within the housing 275 of the prime mover 110, the refrigerant cools the at least once cylinder 280 that is defined within the at least one cooling jacket 210 defined within the housing 275 of the prime mover 110. More specifically, as the substantially liquid refrigerant that is at a high speed, low pressure, and low temperature that is received at the inlet port 270 of the at least one cooling jacket 210 flows through the at least one cooling jacket 210 that is defined within the housing 275 of the prime mover 110, heat from the at least one cylinder 280 that is defined within the at least one cooling jacket 210 is transferred to the liquid refrigerant. The transfer of heat from the at least one cylinder 280 that is defined within the at least one cooling jacket 210 defined within the housing 275 of the prime mover 110 to the liquid refrigerant converts the refrigerant that is in the substantially liquid state to the refrigerant that is in the substantially gaseous state. The refrigerant that is in the substantially gaseous state is therein circulated to an outlet port 229 of the at least one cooling jacket 210 at a higher temperature than that of the liquid refrigerant at the low pressure and the lower temperature that is received at the inlet port 270 of the at least one cooling jacket 210.

In an exemplary embodiment, inner walls of the at least one cooling jacket 210 defined within the housing 275 of the prime mover 110 may be manufactured from a material that can withstand pressurized corrosive liquid refrigerant at low temperature. In an exemplary embodiment, the inner walls of the at least one cooling jacket 210 defined within the housing 275 of the prime mover 110 may be manufactured from but is not limited to a mild steel material. Moreover, the inner walls of the at least one cooling jacket 210 defined within the housing 275 of the prime mover 110 may be coated with a leak resistant coating material to ensure containment of refrigerant within the at least one cooling jacket 210 defined within the housing 275 of the prime mover 110 itself without being discharged to the external environment.

In an exemplary embodiment, a cooling fan 290 is mechanically coupled to the prime mover 110. Mom specifically, the cooling fan 290 that is mechanically coupled to the prime mover 110 receives rotational torque from the prime mover 110 that causes a rotation of the cooling fan 290. In an alternate exemplary embodiment, the cooling fan 290 that is mechanically coupled to the prime mover 110 receives rotational torque from an electric motor (not shown) that receives electric energy from an external power source such but not limited to an electric battery and a wall mounted electric socket. The rotation of the cooling fan 290 that is mechanically coupled to the prime mover 110 facilitates delivering a stream of high speed cooling air to the condenser 230 to cool the refrigerant that is received in the condenser 230 from the outlet port 282 of the compressor 220. More specifically, the condenser 230 is positioned in an air flow path of the cooling fan 290 that is mechanically coupled to the prime mover 110 and receives a stream of high speed cooling air that is discharged from the cooling fan 290 and impinges on an outer surface of the condenser 130. The stream of high speed cooling air that is received from the cooling fan 290 that is mechanically coupled to the prime mover 110 and impinges on the outer surface of the condenser 130 cools the refrigerant that flows to the condenser 230 from the outlet port 282 of the compressor 220. Therefore, the cooling fan 290 facilitates discharging heat from the refrigerant in the condenser 230. More specifically, the heat that was absorbed by the refrigerant that was channeled through the at least one cooling jacket 210 defined within the housing 275 of the prime mover 110 from the prime mover 110, and the heat that was absorbed by the refrigerant that was channeled through the compressor 220 due to compression of the refrigerant in the compressor 220 is therein discharged in the condenser 130 due to the stream of high speed cooling air that is discharged from the cooling fan 290 and impinges on the outer surface of the condenser 230. Therefore, at an outlet port 284 of the condenser 230, substantially gaseous refrigerant at high pressure and a lower temperature than the temperature of the refrigerant at the inlet port 281 of the condenser 130 is channeled to the next stage of the cooling system 100 of the prime mover 110. In an exemplary embodiment, the condenser 130 is in flow communication with the outlet port 282 of the compressor 220 and receives gaseous refrigerant at high pressure and at a high temperature therein.

The refrigerant that flows through the at least one cooling jacket 210 defined within the housing 275 of the prime mover 110 to facilitate cooling the prime mover 110 is of a specific heat absorption capacity that is high. More specifically, the specific heat absorption capacity of the refrigerant that flows through the at least one cooling jacket 210 defined within the housing 275 of the prime mover 110 is higher in comparison with a specific heat absorption capacity of the liquid coolant that is of a specific heat absorption capacity that is lower. Therefore, since the specific heat absorption capacity of the refrigerant that flows through the at least one cooling jacket 210 defined within the housing 275 of the prime mover 110, is higher in comparison with the specific heat absorption capacity of the liquid coolant that is lower, a lower mass flow rate of refrigerant is required to be channeled through the at least one cooling jacket 210 defined within the housing 275 of the prime mover 110. More specifically, the lower mass flow rate of refrigerant is required to be channeled through the at least one cooling jacket 210 defined within the housing 275 of the prime mover 110 to decrease a first temperature of the prime mover 110 to a second temperature in comparison with a higher mass flow rate of liquid coolant that is required to be channeled through the at least one cooling jacket 210 defined within the housing 275 of the prime mover 110 to decrease the first temperature of the prime mover 110 to the second temperature. Therefore, in order to decrease the temperature of the prime mover 110 from the first temperature to the second temperature, a lower mass flow rate of refrigerant is required to be channeled through the at least one cooling jacket 210 defined within the housing 275 of the prime mover 110 in comparison with a higher mass flow rate of liquid coolant that is required to be channeled through the at least one cooling jacket 210 defined within the housing 275 of the prime mover 110. The high specific heat absorption capacity of the liquid refrigerant implies that a low mass flow rate of refrigerant that is channeled through the at least one cooling jacket 210 is sufficient to absorb a substantially same amount of heat from the prime mover 110 as that of a high mass flow rate of liquid coolant that has a comparatively low specific heat absorption capacity.

In an exemplary embodiment, a total amount of energy that is required for operating the compressor 220 to compress refrigerant flowing from the outlet port 229 of the at least one cooling jacket 210 defined within the housing 275 of the prime mover 110 and delivering the compressed refrigerant to an inlet port 281 of the condenser 130, for channeling the refrigerant through the condenser 230, for channeling the refrigerant through the expansion device 240, and finally for channeling the refrigerant through the at least one cooling jacket 210 defined within the housing 275 of the prime mover 110 is lower in comparison with a total amount of energy that is required to operate an electric pump for pumping the liquid coolant, for channeling liquid coolant from the electric pump through a radiator, channeling liquid coolant from an outlet port of the radiator through the at least one cooling jacket 210 defined within the housing 275 of the prime mover 110, channeling liquid coolant from an outlet port 229 of the at least one cooling jacket 210 defined within the housing 275 of the prime mover 110 through the coolant tank, and channeling liquid coolant from an outlet port of the coolant tank 110 through the electric pump. The total amount of energy that is required for channeling the refrigerant through the cooling system 100 of the prime mover 110 is lesser than the total amount of energy that is required for channeling the liquid coolant through the cooling system 100 of the prime mover 110 because the low mass flow rate of refrigerant is required to be channeled through the at least one cooling jacket 210 defined within the housing 275 of the prime mover 110 to decrease the first temperature of the prime mover 110 to the second temperature in comparison with the high mass flow rate of liquid coolant that is required to be channeled through the at least one cooling jacket 210 defined within the housing 275 of the prime mover 110 to decrease the first temperature of the prime mover 110 to the second temperature. The lower mass flow rate of the refrigerant that is required to be channeled through the at least one cooling jacket 210 defined within the housing 275 of the prime mover 110 to cool the prime mover 110 from the first temperature to the second temperature requires a comparatively lower total amount of energy to be supplied to the compressor 120 for circulating the refrigerant through the cooling system 100 of the prime mover 110.

Moreover, the total amount of energy that is required for channeling the refrigerant through the cooling system 100 for the prime mover 110 is lesser than the total amount of energy that is required for channeling the liquid coolant through the cooling system 100 for the prime mover 110 because a low viscosity gaseous refrigerant is channeled through the at least one cooling jacket 210 defined within the housing 275 of the prime mover 110 to decrease the first temperature of the prime mover 110 to the second temperature in comparison with a high viscosity liquid coolant that is channeled through the at least one cooling jacket 210 defined within the housing 275 of the prime mover 110 to decrease the first temperature of the prime mover to the second temperature. The lower viscosity of the refrigerant channeled through the at least one cooling jacket 210 defined within the housing 275 of the prime mover 110 to cool the prime mover 110 from the first temperature to the second temperature requires a lower total amount of energy to be supplied to the compressor 220 for circulating the refrigerant through the cooling system 100 of the prime mover 110. The lower viscosity of the refrigerant implies that a lesser amount of energy is required to circulate the less viscous refrigerant through the cooling system 100 of the prime mover 110 in comparison with greater amount of energy that is required to circulate the comparatively more viscous liquid coolant through the cooling system 100 of the prime mover 110.

In an exemplary embodiment, the prime mover 285 comprises the housing 275, and at least one mechanical component 260 that is positioned within the housing 275 of the prime mover 285. More specifically, the at least one mechanical component 260 that is positioned within the housing 275 of the prime mover 285 converts one of energy to useful work and useful work to energy, and becomes heated up during the process of conversion of one of energy to useful work and useful work to energy respectively. Therefore, the at least one mechanical component 260 that is positioned within the housing 275 of the prime mover 285 is required to be cooled by means of the cooling system 200 for the prime mover 285 to ensure that the temperature of the at least one mechanical component 260 is maintained within acceptable operating temperature limits. In an exemplary embodiment, the first cooling jacket 212 is defined within the housing 275 of the prime mover 285 and adjoins the at least one mechanical component 260 such that the first cooling jacket 212 and the at least one mechanical component 260 is separated by the cylinder 280 defined within the first cooling jacket 212.

In an exemplary embodiment, the first cooling jacket 212 comprises an inlet port 270. More specifically, the inlet port 270 of the first cooling jacket 212 receives refrigerant in the substantially liquid state. The refrigerant that is received in the substantially liquid state via the inlet port 270 of the first cooling jacket 212 flows past the at least one mechanical component 260 that is positioned within the housing 275 of the prime mover 285 and that requires to be cooled, wherein the at least one mechanical component 260 is separated from the first cooling jacket 212 by the cylinder 280 that is defined within the first cooling jacket 212. On flowing past the at least one mechanical component 260 that is positioned within the cylinder 280 that is defined within the first cooling jacket 212 and cooling the at least one mechanical component 260, the refrigerant is channeled through the first cooling jacket 212 to facilitate circulating the refrigerant throughout a complete inner surface area of the first cooling jacket 212. After the refrigerant is circulated through the complete inner surface area of the first cooling jacket 212, the refrigerant is therein channeled through the second cooling jacket 214 that is in flow communication with the first cooling jacket 212 to facilitate cooling at least one mechanical component 260 that is positioned within the second cooling jacket 214. In a similar manner, the third cooling jacket 219 and the fourth cooling jacket 215 are in flow communication with one another in series to ensure a smooth flow of the liquid refrigerant that is channeled through the inlet port 270 of the first cooling jacket 212 to the fourth cooling jacket 215 via the second cooling jacket 214 and via the third cooling jacket 219 that are each in flow communication with one another, and that are positioned between the first cooling jacket 212 and the fourth cooling jacket 215 respectively.

The first cooling jacket 212, the second cooling jacket 214, the third cooling jacket 219, and the fourth cooling jacket 215 contain at least one mechanical component 260 that is positioned within the first cooling jacket 212, the second cooling jacket 214, the third cooling jacket 219, and the fourth cooling jacket 215 and that is required to be cooled by liquid refrigerant that is channeled through the inlet port 270 of the first cooling jacket 212. In an exemplary embodiment, the fourth cooling jacket 215 contains an outlet port 229 that receives the refrigerant that flows through the first cooling jacket 212, the second cooling jacket 214, the third cooling jacket 219, and the fourth cooling jacket 215 respectively. In an alternate exemplary embodiment, the first cooling jacket 212 contains the outlet port 229 that receives the refrigerant that flows through the first cooling jacket 212, the second cooling jacket 214, the third cooling jacket 219, and the fourth cooling jacket 215 and is channeled back to the first cooling jacket 212 via a return flow duct (not shown). As the liquid refrigerant that is in a substantially liquid state flows from the inlet port 270 of the first cooling jacket 212 and circulates through the second cooling jacket 214, the third cooling jacket 219, and the fourth cooling jacket 215 that are in flow communication with the first cooling jacket 212, the liquid refrigerant changes its state to a gaseous state as a consequence of absorbing heat from each at least one mechanical component 260 that is positioned within the first cooling jacket 212, the second cooling jacket 214, the third cooling jacket 219, and the fourth cooling jacket 215 respectively. Thereafter, the refrigerant in the substantially gaseous state is channeled through the outlet port 229 that is in flow communication with the fourth cooling jacket 215 to the next stage of the cooling system 200 of the prime mover 285. During the process of refrigerant flow through the first cooling jacket 212, the second cooling jacket 214, the third cooling jacket 219, and the fourth cooling jacket 215 of the prime mover 285, each of the at least one mechanical component 260 that is positioned within the first cooling jacket 212, the second cooling jacket 214, the third cooling jacket 219, and the fourth cooling jacket 215 of the prime mover 285 are cooled to a temperature that is within its acceptable operating temperature limit. Therefore, the flow of refrigerant that is channeled through the inlet port 270 of the first cooling jacket 212, and channeled through the outlet port 229 of the fourth cooling jacket 215 facilitates decreasing the temperature of the prime mover 285 to the temperature that is within its acceptable operating temperature limit. In an exemplary embodiment, more than four cooling jackets or less than four cooling jackets may be deployed to cool the prime mover 285 depending on a size of the prime mover 285 and an amount of heat that is generated by the prime mover 285.

In an exemplary embodiment, the at least one mechanical component 260 that is positioned within the housing 275 of the prime mover 285 may be one of a windmill blade, a waterwheel blade, a turbine blade, a boiler, a piston, a cylinder wall, stator slot-windings of an electric motor, stator end-windings of the electric motor, stator laminations of the electric motor, rotor laminations of the electric motor, rotor magnets of the electric motor, conductors of the electric motor, stator slot-windings of an electric generator, stator end-windings of the electric generator, stator laminations of the electric generator, rotor laminations of the electric generator, rotor magnets of the electric generator, and conductors of the electric generator respectively. In an alternate exemplary embodiment, the at least one mechanical component 260 that is positioned within the housing 275 of the prime mover 285 may be any kind of a mechanical component that converts one of energy to useful work and useful work to energy respectively, and that requires to be cooled from a higher temperature to a lower temperature by means of the refrigerant that is channeled from the inlet port 270 of the at least one cooling jacket 210 to the outlet port 229 of the at least one cooling jacket 210 via the first cooling jacket 212, the second cooling jacket 214, the third cooling jacket 219, and via the fourth cooling jacket 215 respectively. The electric motor that is positioned within the housing 275 of the prime mover 285 may be one of an alternating current electric motor and a direct current electric motor that facilitates converting electric current to useful work of an output shaft of the prime mover 285.

In addition, the prime mover 285 further comprises the cylinder 280 that is defined within the at least one cooling jacket 210 defined within the housing 275 of the prime mover 285. More specifically, the refrigerant that flows past the at least one mechanical component 260 that is positioned within the housing 275 of the prime mover 285 also flows past the cylinder 280 defined within the at least one cooling jacket 210. Therefore, the refrigerant that flows past the cylinder 280 defined within the at least one cooling jacket 210 cools the cylinder 280 defined within the at least one cooling jacket 210 defined within the housing 275 of the prime mover 285. The cooling of the cylinder 280 defined within the at least one cooling jacket 210 facilitates decreasing the temperature of the prime mover 285 from the higher temperature to the lower temperature respectively and, be within the acceptable operating temperature limit, thereby enhancing a longevity of the cylinder 280 defined within the at least one cooling jacket 210.

In an exemplary embodiment, an inner wall 227 of the at least one cooling jacket 210 defined within the housing 275 of the prime mover 285 may be manufactured from a material that can withstand pressurized liquid refrigerant at a low temperature. More specifically, as the liquid refrigerant flows along the inner wall 227 of the at least one cooling jacket 210, the inner wall 227 of the at least one cooling jacket 210 is susceptible to contraction due to the low temperature pressurized liquid refrigerant, thereby causing deformations to occur on the inner wall 227 of the at least one cooling jacket 210. Therefore, the inner wall 227 of the at least one cooling jacket 210 defined within the housing 275 of the prime mover 285 is required to be manufactured from the material that withstands pressurized liquid refrigerant at low temperature to ensure that the at least one cooling jacket 210 does not break down, thereby causing leakage of the pressurized liquid refrigerant from the at least one cooling jacket 210 to the external environment. Moreover, the at least one cooling jacket 210 defined within the housing 275 of the prime mover 285 may be manufactured from a leak resistant material to ensure containment of liquid/gaseous refrigerant within the at least one cooling jacket 210 defined within the housing 275 of the prime mover 285.

In an exemplary embodiment, the cooling fan 290 is mechanically coupled to the prime mover 285 and receives rotational torque from the prime mover 285. More specifically, the cooling fan 290 is mechanically coupled to the prime mover 285 via a mechanical power transmission assembly (not shown) and receives rotational torque from the mechanical power transmission assembly. The rotational torque that is received from the mechanical power transmission assembly causes a rotation of a plurality of blades 293 that are coupled to the cooling fan 290 that is mechanically coupled to the prime mover 285. The rotation of the plurality of blades 293 that are coupled to the cooling fan 290 causes a steady stream of high speed cooling air from the cooling fan 290 to flow towards and impinge on an outer surface of the condenser 230 to cool refrigerant that is present in the condenser 230. More specifically, the high speed cooling air that is channeled from the cooling fan 290 and impinges on the outer surface of the condenser 230 facilitates withdrawal of heat from the outer surface of the condenser 230 to the external environment due to the process of convection, thereby cooling the refrigerant that is channeled to the condenser 230 from the compressor 220. In an alternate exemplary embodiment, a plurality of fins may be secured to the outer surface of the condenser 230 and receives heat from the outer surface of the condenser 230. The heat that is received by the plurality of fins from the outer surface of the condenser 230 facilitates decreasing a temperature of the condenser 230, thereby causing heat from the refrigerant to be discharged to the external environment and substantially cooling the refrigerant that is present in the condenser 230.

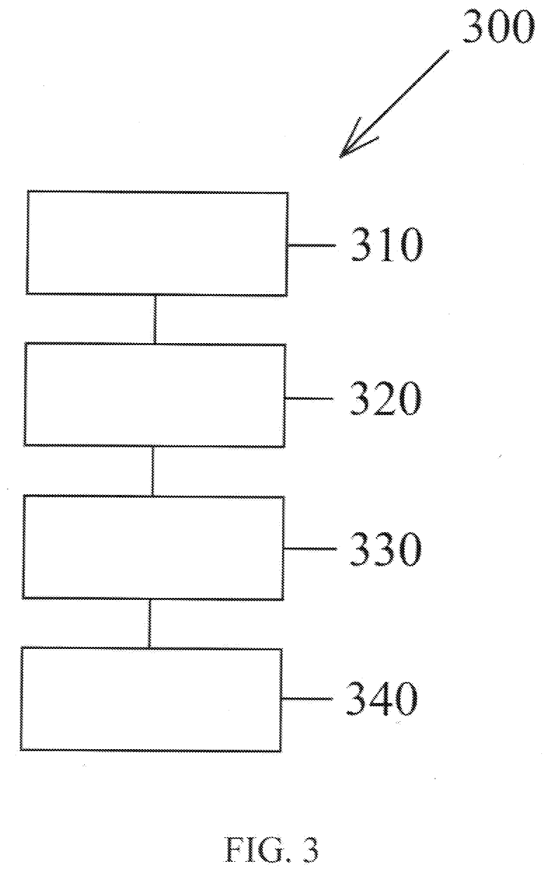

FIG. 3 is a flowchart representing a method 300 of assembling a prime mover 285 in one embodiment of the invention. The method 300 comprises positioning 310 at least one mechanical component 260 within a housing 275 of the prime mover 285, wherein the at least one mechanical component 260 converts one of energy to useful work and useful work to energy, and defining 320 at least one cooling jacket 210 within the housing 275 of the prime mover 285 and positioned around the at least one mechanical component 260, the at least one cooling jacket 210 comprising an inlet port 270 and an outlet port 229. The method further comprises channeling 330 refrigerant in a substantially liquid state through the inlet port 270 of the at least one cooling jacket 210 such that the refrigerant that is channeled in the substantially liquid state through the inlet port 270 of the at least one cooling jacket 210 flows past the at least one mechanical component 260 positioned within the at least one cooling jacket 210 to cool the at least one mechanical component 260 positioned within the at least one cooling jacket 210, and delivering 340 refrigerant that flows past the at least one mechanical component 260 positioned within the housing 275 of the prime mover 285 through the outlet port 229 of the at least one cooling jacket 210 in a substantially gaseous state. The method 300 of assembling a prime mover 285 wherein the step of positioning 310 at least one mechanical component 260 within the at least one cooling jacket 210 comprises positioning one of a windmill blade, a waterwheel blade, a turbine blade, a boiler, a piston, a cylinder wall, stator slot-windings of an electric motor, stator end-windings of the electric motor, stator laminations of the electric motor, rotor laminations of the electric motor, rotor magnets of the electric motor, conductors of the electric motor, stator slot-windings of an electric generator, stator end-windings of the electric generator, stator laminations of the electric generator, rotor laminations of the electric generator, rotor magnets of the electric generator, and conductors of the electric generator within the housing 275 of the prime mover 285. In an exemplary embodiment, the electric motor may be an electric motor of an electric automobile that converts electric energy that is supplied to the electric motor to useful shaft work. The method 300 of assembling the prime mover 285, wherein positioning the electric motor within the at least one cooling jacket 210 further comprises positioning one of an alternating current electric motor and a direct current electric motor within the at least one cooling jacket 210 defined within the housing 275 of the prime mover 285.

The method 300 of assembling the prime mover 285 further comprises defining 320 at least one cylinder 280 within the at least one cooling jacket 210 defined within the housing 275 of the prime mover 285. More specifically, the refrigerant that flows past the at least one mechanical component 260 positioned within the at least one cooling jacket 210 cools the at least one cylinder 280 defined within the at least one cooling jacket 210 defined within the housing 275 of the prime mover 285. In addition, inner walls of the at least one cooling jacket 210 defined within the housing 275 of the prime mover 285 may be manufactured from a material that can withstand pressurized corrosive liquid refrigerant at low temperature. Moreover, the at least one cooling jacket 210 defined within the housing 275 of the prime mover 285 and positioned around the at least one mechanical component 260 may be coated with a leak resistant coating material to ensure containment of substantially gaseous refrigerant within the at least one cooling jacket 210 defined within the housing 275 of the prime mover 285. The method 300 of assembling the prime mover 285 comprises mechanically coupling a cooling fan 290 to the prime mover 285 and receiving rotational torque from one of the prime mover 285 and an electric motor. On receiving the rotational torque from one of the prime mover 285 and the electric motor, the cooling fan 290 supplies a stream of high velocity cooling air to the condenser 230 to cool refrigerant that is received in the condenser 230 from the at least one cooling jacket 210 defined in the housing 275 of the prime mover 285.

A working of the cooling system 200 for the prime mover 285 is described as an example. In an exemplary embodiment, the refrigerant in the substantially liquid state is received within the at least one cooling jacket 210 via the inlet port 270 that is defined in the at least one cooling jacket 210. Once the liquid refrigerant is channeled within the at least one cooling jacket 210 via the inlet port 270, the liquid refrigerant is allowed to flow through the at least one cooling jacket 210 defined within the housing 275 of the prime mover 285 to facilitate cooling the prime mover 285. More specifically, once the liquid refrigerant flows through the inlet port 270 of the at least one cooling jacket 210, the liquid refrigerant is channeled through the first cooling jacket 212, and through the second cooling jacket 214 that is in flow communication with the first cooling jacket 212, through the third cooling jacket 219 that is in flow communication with the second cooling jacket 214, and through the fourth cooling jacket 215 that is in flow communication with the third cooling jacket 219. The flow of liquid refrigerant through the first cooling jacket 212, through the second cooling jacket 214, through the third cooling jacket 219, and through the fourth cooling jacket 215 facilitates cooling the prime mover 285. More specifically, as the liquid refrigerant flows through the first cooling jacket 212, through the second cooling jacket 214, through the third cooling jacket 219, and through the fourth cooling jacket 215 respectively, the liquid refrigerant absorbs heat from the prime mover 285 that becomes heated up during the process of conversion of one of energy to useful work and useful work to energy. The absorption of heat by the liquid refrigerant from the prime mover 285 changes its phase from the liquid phase to the gaseous phase as it flows through the first cooling jacket 212, through the second cooling jacket 214, through the third cooling jacket 219, and through the fourth cooling jacket 215 respectively. Therefore, when the liquid refrigerant enters the inlet port 270 of the first cooling jacket 212, the liquid refrigerant is at low temperature and at low pressure. However, as the liquid refrigerant changes its phase to the gaseous phase during the process of heat absorption from the prime mover 285 as it flows through the first cooling jacket 212, through the second cooling jacket 214, through the third cooling jacket 219, and through the fourth cooling jacket 215 respectively, the gaseous refrigerant that exits from the outlet port 229 of the fourth cooling jacket 215 is at high temperature and at low pressure. As heat flows from the prime mover 285 to the refrigerant that flows through the inlet port 270 of the at least one cooling jacket 210, through the first cooling jacket 212, through the second cooling jacket 214, through the third cooling jacket 219, through the fourth cooling jacket 215, and through the outlet port 229 of the at least one cooling jacket 210 that surrounds the housing 275 of the prime mover 285, the prime mover 285 is thereby cooled from the higher temperature to the lower temperature.

The refrigerant at the outlet port 229 of the at least one cooling jacket 210 defined within the housing 275 of the prime mover 285 which is in the gaseous state at high temperature and at low pressure is channeled to an inlet port 231 of the compressor 220. Once the gaseous refrigerant is received in the compressor 220, the gaseous refrigerant is compressed by the compressor 220 from a pressure that is equal to the pressure of the refrigerant at the outlet port 229 of the at least one cooling jacket 210 to a higher pressure that is required for the refrigerant to be circulated through the cooling system 200 for the prime mover 285. Therefore, as the gaseous refrigerant at high temperature and low pressure flows through the compressor 220, the compressor 220 increases the pressure of the refrigerant from the low pressure to a high pressure with a corresponding large increase in temperature of the refrigerant. Therefore, at the outlet port 282 of the compressor 220, the gaseous refrigerant is at a higher temperature than the gaseous refrigerant that is channeled to the inlet port 231 of the compressor 220 from the outlet port 229 of the at least one cooling jacket 210 defined within the housing 275 of the prime mover 285, and at a higher pressure than the gaseous refrigerant that is channeled to the inlet port 231 of the compressor 220 from the outlet port 229 of the at least one cooling jacket 210 defined within the housing 275 of the prime mover 285.

The refrigerant at the outlet port 282 of the compressor 220 which is in the gaseous state at high temperature and at high pressure is channeled to an inlet port 281 of the condenser 230. Once the gaseous refrigerant is received within the condenser 230, heat that is present within the gaseous refrigerant that was absorbed from the prime mover 285 while the refrigerant was flowing through the at least one cooling jacket 210 and heat that was absorbed in the compressor 220 while the gaseous refrigerant was being compressed in the compressor 220 is dissipated in the condenser 230. More specifically, the cooling fan 290 that is mechanically coupled to the housing 275 of the prime mover 285 receives rotational torque from the prime mover 285. Therein, the cooling fan 290 that is mechanically coupled to the housing 275 of the prime mover 285 rotates, thereby channeling cooling air at high speed to the outer surface of the condenser 230. The cooling air from the cooling fan 290 at high speed that impinges on the outer surface of the condenser 230 channels heat away from the gaseous refrigerant that flows through a plurality of coiled pipes 233 in the condenser 230. More specifically, the plurality of coiled pipes 233 is in flow communication with the inlet port 281 of the condenser 230 at its one end and in flow communication with the outlet port 284 of the condenser 230 at its opposite second end and channels gaseous refrigerant through the condenser 230 to discharge heat from the gaseous refrigerant in the condenser 230. The coiled nature of the plurality of coiled pipes 233 facilitate increasing a length of travel of the gaseous refrigerant through a length of the condenser 230 to facilitate discharging heat from the gaseous refrigerant in the condenser 230 effectively. Due to heat in the gaseous refrigerant that is channeled away by the cooling air at high speed that impinges on the outer surface of the condenser 230, the temperature of the refrigerant that flows through the coiled pipes 233 from the inlet port 281 of the condenser 230 to the outlet port 284 of the condenser 230 is decreased from the temperature of the refrigerant at the inlet port 281 of the condenser 230 to a lower temperature at the outlet port 284 of the condenser 230 that is required for the refrigerant to be circulated through the cooling system 200 for the prime mover 285. While the temperature of the refrigerant decreases from the temperature at the outlet port 282 of the compressor 220 to the lower temperature as the refrigerant flows through the coiled pipes 233 of the condenser 230, the pressure of the refrigerant as refrigerant flows through the condenser 230 remains steady or decreases to a slightly lower pressure from the high pressure gaseous refrigerant that is channeled from the outlet port 282 of the compressor 220 to the inlet port 281 of the condenser 230. Therefore, at the outlet port 284 of the condenser 230, the gaseous refrigerant is at a relatively lower temperature than the gaseous refrigerant that is channeled to the inlet port 281 of the condenser 230 from the outlet port 282 of the compressor 220, and at a substantially same pressure or slightly lower pressure as the gaseous refrigerant that is channeled to the inlet port 281 of the condenser 230 from the outlet port 282 of the compressor 220.

The refrigerant at the outlet port 284 of the condenser 230 which is in the gaseous state at low temperature and at high pressure is channeled to an inlet port 241 of the expansion device 240. The expansion device 240 is in flow communication with the outlet port 284 of the condenser 230 at its inlet port 241 and receives refrigerant that flows through the outlet port 284 of the condenser 230. Once the refrigerant is received at the inlet port 241 of the expansion device 240 in a substantially gaseous state, the expansion device 240 facilitates throttling the gaseous refrigerant thereby decreasing the pressure of the refrigerant that exits from the outlet port 284 of the condenser 230 to a lower pressure that exits from the outlet port 247 of the expansion device 240. Due to the decrease in the pressure of the refrigerant due to the throttling effect of the expansion device 240, the temperature of the refrigerant is decreased from the low temperature at the inlet port 241 of the expansion device 240 to a relatively much lower temperature that exits from the outlet port 247 of the expansion device 240. The expansion device 240 is in flow communication with the inlet port 270 of the at least one cooling jacket 210 defined within the housing 275 of the prime mover 285 at its outlet port 247. The expansion device 240 controls a flow of refrigerant that flows through the outlet port 284 of the condenser 230 to the inlet port 270 of the at least one cooling jacket 210 defined within the housing 275 of the prime mover 285, wherein the expansion device 240 is electronically controlled by means of an engine control unit 250 that is in electronic communication with the expansion device 240 via the control flow path 271. More specifically, the engine control unit 250 controls an opening percentage of the expansion device 240 to facilitate regulating a required mass flow rate of the refrigerant from the outlet port 284 of the condenser 230 to the inlet port 270 of the at least one cooling jacket 210 defined within the housing 275 of the prime mover 285 for the refrigerant to be circulated through the cooling system 200 for the prime mover 285.

As the pressure and the temperature of the refrigerant decreases from high pressure and low temperature at the outlet port 284 of the condenser 230 to low pressure and much lower temperature that is required for the refrigerant to be circulated through the cooling system 200 for the prime mover 285, the refrigerant changes its phase to a substantially liquid phase due to the decrease in the temperature of the refrigerant below a phase transition temperature of the refrigerant that flows through the outlet port 247 of the expansion device 240. Moreover, the throttling of the refrigerant that flows through the outlet port 284 of the condenser 230 to the inlet port 270 of the at least one cooling jacket 210 via the expansion device 240 that is controlled by the engine control unit 250 via the control flow path 271 permits only a required mass flow rate of refrigerant to be channeled at high speed through the inlet port 270 of the at least one cooling jacket 210. Therefore, at the outlet port 247 of the expansion device 240, substantially liquid refrigerant is at a lower pressure than the refrigerant that is channeled to the inlet port 241 of the expansion device 240 from the outlet port 284 of the condenser 230 and is at a lower temperature than the refrigerant that is channeled to the inlet port 241 of the expansion device 240 from the outlet port 284 of the condenser 230. In an exemplary embodiment, the inlet port 270 of the at least one cooling jacket 210 defined within the housing 275 of the prime mover 285 is in flow communication with the outlet port 247 of the expansion device 240 and receives high speed liquid refrigerant at low pressure and at low temperature therein. After the refrigerant in the substantially liquid state at low pressure and at low temperature is channeled to the inlet port 270 of the at least one cooling jacket 210, the cycle is repeated once more with the flow of liquid refrigerant through the at least one cooling jacket 210 defined within the housing 275 of the prime mover 285 to cool the prime mover 285 in the subsequent cycle.

The advantages of the cooling system 200 for the prime mover 285 are now outlined below for the understanding of a reader. Since a low mass flow rate of refrigerant is required to be channeled through the at least one cooling jacket 210 defined within the housing 275 of the prime mover 285 to decrease the first temperature of the prime mover 285 to the second temperature in comparison with the high mass flow rate of liquid coolant that is required to be channeled through the at least one cooling jacket 210 defined within the housing 275 of the prime mover 285 to decrease the first temperature of the prime mover 285 to the second temperature, the total amount of energy that is required to be expended for operating the compressor 220 to compress refrigerant flowing from the outlet port 229 of the at least one cooling jacket 210 defined within the housing 275 of the prime mover 285 and delivering the compressed refrigerant from the outlet port 282 of the compressor 220 to the inlet port 281 of the condenser 230 for channeling the refrigerant through the condenser 230, for channeling the refrigerant through the expansion device 240, and finally for channeling the refrigerant through the at least one cooling jacket 210 defined within the housing 275 of the prime mover 285 is much lower in comparison with the total amount of energy that is required to be expended for operating the electric pump for channeling liquid coolant from the electric pump through the radiator, channeling liquid coolant flowing from the radiator through the at least one cooling jacket 210 defined within the housing 275 of the prime mover 285, channeling liquid coolant flowing from the at least one cooling jacket 210 defined within the housing 275 of the prime mover 285 through the coolant tank, and channeling liquid coolant flowing from the coolant tank through the electric pump. Therefore, since the low mass flow rate of refrigerant is required to be channeled through the at least one cooling jacket 210 defined within the housing 275 of the prime mover 285 to cool the prime mover 285 by decreasing the first temperature of the prime mover 285 to the second temperature in comparison with the high mass flow rate of liquid coolant that is required to be channeled through the at least one cooling jacket 210 defined within the housing 275 of the prime mover 285 to cool the prime mover 285 by decreasing the first temperature of the prime mover 285 to the second temperature, the total amount of energy that is required to be supplied to the compressor 220 for circulating the refrigerant through the cooling system 200 of the prime mover 285 is much lesser than the total amount of energy that is required for channeling the liquid coolant through the cooling system 200 for the prime mover 285.

In addition, since a low viscosity gaseous refrigerant is required to be channeled through the at least one cooling jacket 210 defined within the housing 275 of the prime mover 285 to cool the prime mover 285 by decreasing the first temperature of the prime mover 285 to the second temperature in comparison with a high viscosity liquid coolant that is required to be channeled through the at least one cooling jacket 210 defined within the housing 275 of the prime mover 285 to cool the prime mover 285 by decreasing the first temperature of the prime mover 285 to the second temperature, the total amount of energy that is required to be expended for channeling the refrigerant through the cooling system 200 for the prime mover 285 is much lesser than the total amount of energy that is required to be expended for channeling the liquid coolant through the cooling system 200 for the prime mover 285. Therefore, since the viscosity of the refrigerant that is required to be channeled through the at least one cooling jacket 210 defined within the housing 275 of the prime mover 285 to cool the prime mover 285 from the first temperature to the second temperature is low, the total amount of energy that is required to be supplied to the compressor 220 for operating the compressor 220 and circulating the refrigerant through the cooling system 200 of the prime mover 285 is much lesser than the total amount of energy that is required to operate the electric pump for channeling liquid coolant through the cooling system 200 of the prime mover 285 to cool the prime mover 285.

Further, the material cost savings associated with utilizing the liquid refrigerant for cooling the prime mover 285 that does not require to be replaced over an entire lifespan of a vehicle is much higher than utilizing the liquid coolant that is currently being deployed for cooling the prime mover 285 that requires to be replaced several times over the entire lifespan of the vehicle. In addition, a maintenance cost associated with maintaining the proposed cooling system 200 for the prime mover 285 utilizing the liquid refrigerant that requires minimal service and mechanical maintenance is much lower than the maintenance cost associated with maintaining the current cooling system 200 for the prime mover 285 utilizing the liquid coolant that requires periodic maintenance and service. Therefore, the overall benefits associated with deploying the proposed liquid refrigerant that is to be circulated through the cooling system 200 of the prime mover 285 to cool the prime mover 285 is much better than the overall benefits associated with deploying the liquid coolant that is currently being circulated through the cooling system 200 of the prime mover 285 to cool the prime mover 285.

Exemplary embodiments of a cooling system 200 for a prime mover 285 for cooling the prime mover 285 is described above in detail. The systems are not limited to the specific embodiments described herein, but rather, components of each system may be utilized separately and independently from other components described herein. In addition, the terms ‘prime mover’, ‘engine’, ‘internal combustion engine’, and ‘electric motor’ may be used interchangeably herein in this manuscript.

While the invention has been described in terms of various specific embodiments, those skilled in the art will recognize that the invention can be practiced with modifications within the spirit and scope of the claims.

What is claimed is:

1. A cooling system for a prime mover that converts one of energy to useful work and useful work to energy, said cooling system comprising:
at least one cooling jacket defined within a housing of said prime mover and receives a refrigerant therein, wherein the refrigerant that is received within the at least one cooling jacket flows through the at least one cooling jacket defined within said housing of said prime mover to cool said prime mover;
a compressor in flow communication with an outlet of the at least one cooling jacket defined within said housing of said prime mover, the compressor receives refrigerant that flows through the outlet of the at least one cooling jacket, said compressor compresses the refrigerant that is received in said compressor;
a condenser in flow communication with an outlet of said compressor, the condenser receives refrigerant that flows through the outlet of said compressor, said condenser discharges heat from the refrigerant that is received in said condenser; and
an expansion device in flow communication with an outlet of said condenser at its inlet and receives refrigerant that flows through the outlet of said condenser, said expansion device in flow communication with an inlet of the at least one cooling jacket defined within said housing of said prime mover at its outlet, wherein said expansion device controls a flow of refrigerant that flows through the outlet of said condenser to the inlet of the at least one cooling jacket defined within said housing of said prime mover.

2. A cooling system for a prime mover in accordance with claim 1, wherein said prime mover may be one of a windmill, a waterwheel, a turbine, a steam engine, a steam generator, an internal combustion engine, an external combustion engine, an electric motor, and an electric generator.

3. A cooling system for a prime mover in accordance with claim 2, wherein said electric motor may be one of an alternating current electric motor and a direct current electric motor.

4. A cooling system for a prime mover in accordance with claim 1, further comprising at least one cylinder defined within the at least one cooling jacket defined within said housing of said prime mover, the refrigerant that flows through the at least one cooling jacket defined within said housing of said prime mover cools the at least one cylinder defined within the at least one cooling jacket defined within said housing of said prime mover.

5. A cooling system for a prime mover in accordance with claim 1, wherein inner walls of the at least one cooling jacket defined within said housing of said prime mover may be of a material that can withstand corrosive liquid refrigerant at high pressure and low temperature, and wherein inner walls of the at least one cooling jacket defined within said housing of said prime mover may be of a leak resistant material to ensure containment of refrigerant within the at least one cooling jacket defined within said housing of said prime mover.

6. A cooling system for a prime mover in accordance with claim 1, further comprising a cooling fan mechanically coupled to said prime mover and receives rotational torque from one of said prime mover and an electric motor, said cooling fan supplies a stream of cooling air to said condenser to cool the refrigerant that is received in said condenser from the outlet of said compressor.

7. A cooling system for a prime mover in accordance with claim 1, wherein the refrigerant that flows through the at least one cooling jacket defined within said housing of said prime mover to cool said prime mover is of a specific heat absorption capacity that is greater in comparison with that of a liquid coolant, thereby allowing for a low mass flow rate of refrigerant to be channeled through the at least one cooling jacket defined within said housing of said prime mover to decrease a first temperature of said prime mover to a second temperature in comparison with a high mass flow rate of liquid coolant to be channeled through the at least one cooling jacket defined within said housing of said prime mover to decrease the first temperature of said prime mover to the second temperature.

8. A cooling system for a prime mover in accordance with claim 1, wherein a total amount of energy required to operate said compressor for compressing the refrigerant, for channeling the refrigerant through said condenser, for channeling the refrigerant through said expansion device, and for channeling the refrigerant through the at least one cooling jacket defined within said housing of said prime mover is lesser in comparison with total amount of energy required to operate an electric pump to pump liquid coolant, to circulate liquid coolant through a radiator, to circulate liquid coolant through the at least one cooling jacket defined within said housing of said prime mover, and to circulate liquid coolant through the coolant tank that is greater because at least one of:
a low mass flow rate of refrigerant is required to be channeled through the at least one cooling jacket defined within said housing of said prime mover to decrease a first temperature of said prime mover to a second temperature in comparison with a high mass flow rate of liquid coolant that is required to be channeled through the at least one cooling jacket defined within said housing of said prime mover to decrease the first temperature of said prime mover to the second temperature; and
a low viscosity gaseous refrigerant is required to be channeled through the at least one cooling jacket defined within said housing of said prime mover to decrease the first temperature of said prime mover to the second temperature in comparison with a high viscosity liquid coolant that is required to be channeled through the at least one cooling jacket defined within said housing of said prime mover to decrease the first temperature of said prime mover to the second temperature.

9. A cooling system for a prime mover in accordance with claim 1, further comprising an outlet valve in flow communication between the outlet of the at least one cooling jacket and an inlet of the compressor and controls a flow of refrigerant from the outlet of the at least one cooling jacket to the inlet of the compressor.

10. A prime mover, said prime mover comprising:
a housing;
at least one mechanical component positioned within said housing of said prime mover, said at least one mechanical component converts one of energy to useful work and useful work to energy; and
at least one cooling jacket defined within said housing of said prime mover and defined around said at least one mechanical component, the at least one cooling jacket comprises an inlet and an outlet, the inlet of the at least one cooling jacket receives refrigerant in a substantially liquid state at a low temperature, wherein the refrigerant in the substantially liquid state at the low temperature that is received through the inlet of the at least one cooling jacket flows past said at least one mechanical component positioned within the at least one cooling jacket to cool said at least one mechanical component positioned within the at least one cooling jacket, wherein the refrigerant is therein delivered through the outlet of the at least one cooling jacket in a substantially gaseous state at a high temperature due to absorption of heat by the refrigerant from said at least one mechanical component positioned within the at least one cooling jacket.

11. A prime mover in accordance with claim 10, wherein said at least one mechanical component positioned within the at least one cooling jacket may be one of a windmill blade, a waterwheel blade, a turbine blade, a boiler, a piston, a cylinder wall, stator slot-windings of an electric motor, stator end-windings of said electric motor, stator laminations of said electric motor, rotor laminations of said electric motor, rotor magnets of said electric motor, conductors of said electric motor, stator slot-windings of an electric generator, stator end-windings of said electric generator, stator laminations of said electric generator, rotor laminations of said electric generator, rotor magnets of said electric generator, and conductors of said electric generator.

12. A prime mover in accordance with claim 11, wherein said electric motor may be one of an alternating current electric motor and a direct current electric motor.

13. A prime mover in accordance with claim 10, further comprising at least one cylinder defined within the at least one cooling jacket defined within said housing of said prime mover and surrounding said at least one mechanical component, the refrigerant that flows past said at least one mechanical component positioned within the at least one cooling jacket cools the at least one cylinder defined within the at least one cooling jacket defined within said housing of said prime mover and surrounding said at least one mechanical component from a higher temperature to a lower temperature.

14. A prime mover in accordance with claim 10, wherein inner walls of the at least one cooling jacket defined within said housing of said prime mover may be of a material that can withstand pressurized corrosive liquid refrigerant at low temperature, and wherein the at least one cooling jacket defined within said housing of said prime mover may be of a leak resistant material to ensure containment of substantially gaseous refrigerant within the at least one cooling jacket defined within said housing of said prime mover.

15. A prime mover in accordance with claim 10, further comprising a cooling fan mechanically coupled to said prime mover and receives rotational torque from one of said prime mover and an electric motor, said cooling fan supplies a stream of cooling air to a condenser to cool refrigerant that is received in said condenser from the at least one cooling jacket defined in said housing of said prime mover.

16. A method of assembling a prime mover, the method comprising:
positioning at least one mechanical component within a housing of the prime mover, wherein the at least one mechanical component converts one of energy to useful work and useful work to energy;
defining at least one cooling jacket within the housing of the prime mover and defined around the at least one mechanical component, the at least one cooling jacket comprising an inlet and an outlet;
channeling refrigerant in a substantially liquid state at a low temperature through the inlet of the at least one cooling jacket such that the refrigerant that is channeled in the substantially liquid state at the low temperature through the inlet of the at least one cooling jacket flows past the at least one mechanical component positioned within the at least one cooling jacket to cool the at least one mechanical component positioned within the at least one cooling jacket; and
delivering refrigerant that flows past the at least one mechanical component positioned within the at least one cooling jacket to cool the at least one mechanical component positioned within the at least one cooling jacket through the outlet of the at least one cooling jacket in a substantially gaseous state at a high temperature due to absorption of heat by the refrigerant from the at least one mechanical component positioned within the at least one cooling jacket.

17. A method of assembling a prime mover in accordance with claim 16, wherein positioning at least one mechanical component within the at least one cooling jacket comprises positioning one of a windmill blade, a waterwheel blade, a turbine blade, a boiler, a piston, a cylinder wall, stator slot-windings of an electric motor, stator end-windings of the electric motor, stator laminations of the electric motor, rotor laminations of the electric motor, rotor magnets of the electric motor, conductors of the electric motor, stator slot-windings of an electric generator, stator end-windings of the electric generator, stator laminations of the electric generator, rotor laminations of the electric generator, rotor magnets of the electric generator, and conductors of the electric generator within the at least one cooling jacket defined within the housing of the prime mover.

18. A method of assembling a prime mover in accordance with claim 17, wherein positioning the electric motor within the at least one cooling jacket further comprises positioning one of an alternating current electric motor and a direct current electric motor within the at least one cooling jacket defined within the housing of the prime mover.

19. A method of assembling a prime mover in accordance with claim 16, further comprising defining at least one cylinder within the at least one cooling jacket defined within the housing of the prime mover and surrounding the at least one mechanical component, the refrigerant that flows past the at least one mechanical component positioned within the at least one cooling jacket cools the at least one cylinder defined within the at least one cooling jacket defined within the housing of the prime mover and surrounding the at least one mechanical component from a higher temperature to a lower temperature.

20. A method of assembling a prime mover in accordance with claim 16, wherein inner walls of the at least one cooling jacket defined within the housing of the prime mover may be of a material that can withstand pressurized corrosive liquid refrigerant at low temperature, and wherein the at least one cooling jacket defined within the housing of the prime mover may be of a leak resistant material to ensure containment of substantially gaseous refrigerant within the at least one cooling jacket defined within the housing of the prime mover.

21. A method of assembling a prime mover in accordance with claim 16, further comprising mechanically coupling a cooling fan to the prime mover and receiving rotational torque from one of the prime mover and an electric motor, wherein the cooling fan supplies a stream of cooling air to a condenser to cool refrigerant that is received in the condenser from the at least one cooling jacket defined in the housing of the prime mover.
